(19) United States
(12) Patent Application Publication
(10) Pub. No.: US 2014/0129453 A1
(43) Pub. Date: May 8, 2014

(54) Personal Concierge on Mobile Computing Device

(71) Applicant: Robert Brazell, Salt Lake City, UT (US)

(72) Inventor: Robert Brazell, Salt Lake City, UT (US)

(21) Appl. No.: 13/926,933

(22) Filed: Jun. 25, 2013

Related U.S. Application Data
(60) Provisional application No. 61/721,613, filed on Nov. 2, 2012.

(51) Int. Cl. G06Q 50/12; G06Q 30/00

(52) U.S. Cl. CPC G06Q 50/12; G06Q 30/016
USPC 705/304

(57) ABSTRACT

The present invention extends to methods, systems, and computer program products for providing a personal concierge to guests of a hotel or other establishment. The personal concierge can be provided in the form of a mobile application. The mobile application can be executed on a guest's mobile phone or other mobile electronic device so that the personal concierge can continuously assist the guest. The personal concierge can interface with various devices within or around a hotel such as the devices within a guest's room. The personal concierge can be configured to identify a guest's preferences or habits to better provide suggestions or assistance during a stay.

### CROSS-REFERENCE TO RELATED APPLICATIONS

This application claims the benefit of U.S. Provisional Patent Application No.: 61/721,613 which was filed on Nov. 2, 2012.

### BACKGROUND

Many hotels provide a concierge to assist its guests in various ways such as making reservations at restaurants or spas, arranging transportation, and purchasing tickets to events. Generally, the hotel includes a concierge desk in the main lobby where the guests can request assistance or receive information from the concierge.

Due to the relatively short duration of their stay at a hotel, guests generally do not develop a relationship with any particular concierge. For this reason, a concierge is only able to provide generalized impersonal assistance to the hotel guests. Further, although a concierge is often available at any time, a concierge does not provide continuous assistance or guidance to a guest.

### BRIEF SUMMARY

The present invention extends to methods, systems, and computer program products for providing a personal concierge to guests of a hotel or other establishment. The personal concierge can be provided in the form of a mobile application. The mobile application can be executed on a guest's mobile phone or other mobile electronic device so that the personal concierge can continuously assist the guest. The personal concierge can interface with various devices within or around a hotel such as the devices within a guest's room. The personal concierge can be configured to identify a guest's preferences or habits to better provide suggestions or assistance during a stay.

In one embodiment, a method for providing a personal concierge to a guest of a hotel includes detecting the presence of a mobile computing device of a guest at a location within a hotel. A request is audibly output from the mobile computing device. The request is based on the location of the mobile computing device. Vocal input is received from the guest in response to the request. Based on the vocal input from the guest, a communication is then transmitted to another computer system.

In another embodiment, a method for providing a personal concierge on a mobile computing device includes receiving vocal input at the mobile computing device from a guest of a hotel. The vocal input includes a request to control a device within the guest's room in the hotel. The vocal input is processed to identify the request. An identifier of the guest is also identified. A command for implementing the requested control is created. The command includes the identifier of the guest. The command is sent to the device within the guest's room to control the device.

In another embodiment, a mobile phone application provides a personal concierge to a guest of a hotel. The mobile phone application detects the location of the mobile phone within a hotel. Based on the location within the hotel, the mobile phone application outputs an audible command to the guest. In response to the audible command, the mobile phone application receives a vocal response from the guest. The mobile phone application then generates a command based on the vocal response to control a device located within the hotel.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computing environment in which a mobile application can provide a personal concierge according to embodiments of the invention;

FIG. 2 illustrates an example of a personal concierge application that can be executed on a mobile computing device to provide personal concierge services;

FIG. 3 illustrates an example of how a personal concierge application can cause control signals to be transmitted directly to one or more devices to control the devices in accordance with commands received from a guest;

FIG. 4 illustrates an example of how a personal concierge application can cause control signals to be transmitted over a network to control one or more devices in accordance with commands received from a guest;

FIG. 5 illustrates an example of how a personal concierge application can notify a guest when the guest is in a particular location;

FIG. 6 illustrates a flowchart of an example method for detecting the presence of a mobile computing device of a guest at a location within a hotel; and

FIG. 7 illustrates a flowchart of an example method for providing a personal concierge on a mobile computing device.

### DETAILED DESCRIPTION

The present invention extends to methods, systems, and computer program products for providing a personal concierge to guests of a hotel or other establishment. The personal concierge can be provided in the form of a mobile application. The mobile application can be executed on a guest's mobile phone or other mobile electronic device so that the personal concierge can continuously assist the guest. The personal concierge can interface with various devices within or around a hotel such as the devices within a guest's room. The personal concierge can be configured to identify a guest's preferences or habits to better provide suggestions or assistance during a stay.

In one embodiment, a method for providing a personal concierge to a guest of a hotel includes detecting the presence of a mobile computing device of a guest at a location within a hotel. A request is audibly output from the mobile computing device. The request is based on the location of the mobile computing device. Vocal input is received from the guest in response to the request. Based on the vocal input from the guest, a communication is then transmitted to another computer system.

In another embodiment, a method for providing a personal concierge on a mobile computing device includes receiving vocal input at the mobile computing device from a guest of a hotel. The vocal input includes a request to control a device within the guest's room in the hotel. The vocal input is processed to identify the request. An identifier of the guest is also identified. A command for implementing the requested control is created. The command includes the identifier of the guest. The command is sent to the device within the guest's room to control the device.

In another embodiment, a mobile phone application provides a personal concierge to a guest of a hotel. The mobile phone application detects the location of the mobile phone within a hotel. Based on the location within the hotel, the mobile phone application outputs an audible command to the guest. In response to the audible command, the mobile phone application receives a vocal response from the guest. The mobile phone application then generates a command based on the vocal response to control a device located within the hotel.

Example Computer Architecture

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Example Computer Environment

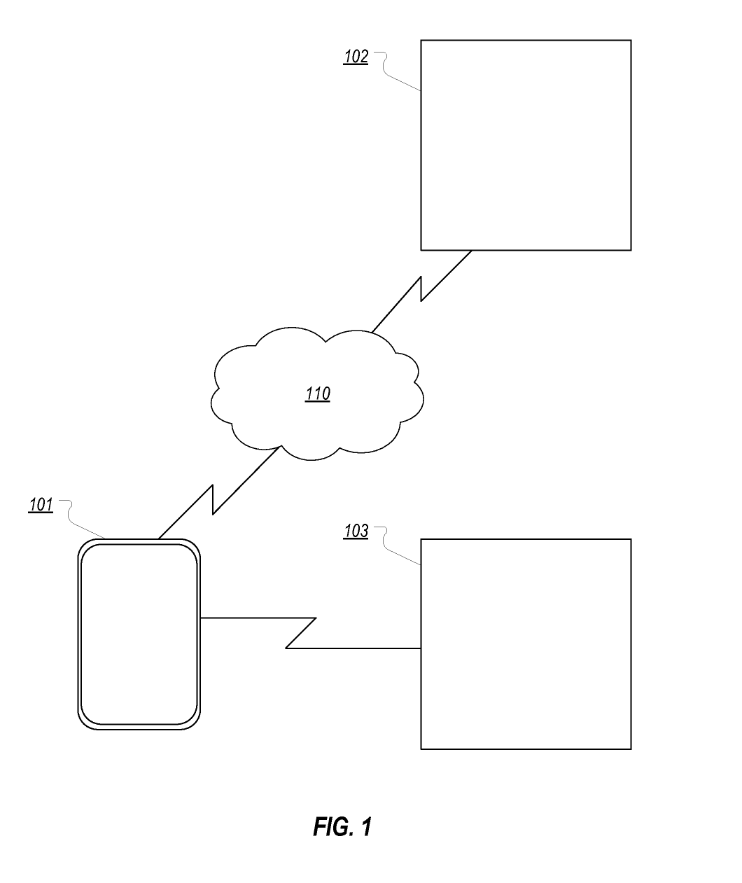

FIG. 1 illustrates an example computer environment 100 in which a personal concierge can be provided on a mobile computing device 101. In a typical embodiment, mobile computing device 101 represents a guest's mobile phone or tablet. However, mobile computing device 101 can represent any type of mobile computing device.

As shown, mobile computing device 101 can communicate in various ways. Mobile computing device 101 is shown as being capable of communicating with another computer system 102 via a network 110. Network 110 can represent any network such as a local area network or the internet. Computer system 102 can represent any computer system capable of communicating with mobile computing device 101 via network 110. For example, computer system 102 can be a server or cloud of servers connected to mobile computing device 101 via the internet, or can be a television in a hotel room that is connected to a local area network.

Mobile computing device 101 can also communicate directly with another computer system 103. For example, computer system 103 can represent a GPS satellite transmitting GPS data to mobile computing device 101 or a device located within a hotel that transmits information regarding the location of mobile computing device within the hotel. Other types of computer systems 103 can also communicate directly with mobile computing device 101 (e.g. via infrared, Bluetooth, Wi-Fi direct, etc.).

Personal Concierge Application

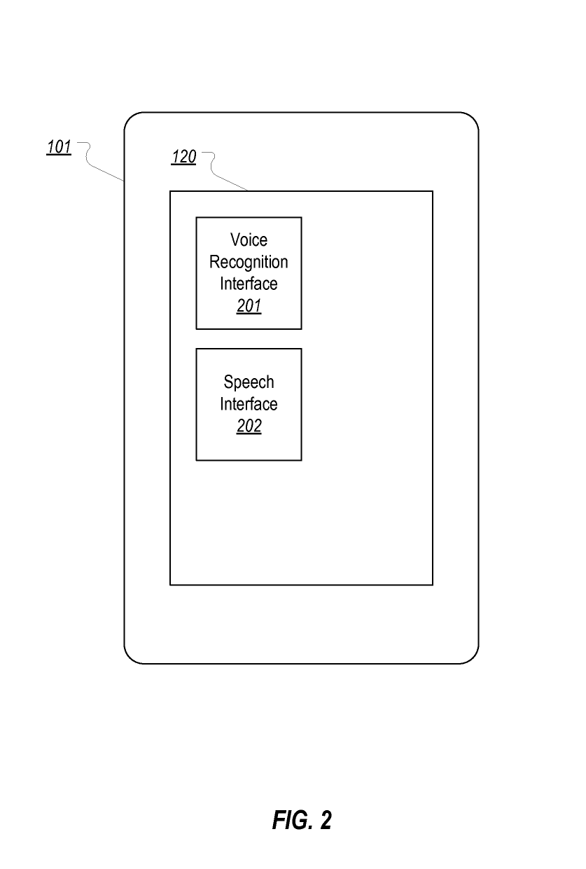

As shown in FIG. 2, mobile computing device 101 executes a personal concierge application 120 that can receive data from and send data to computer systems 102 and 103. The data can be used to provide personal concierge services to a user of mobile computing device 101 while the user is a guest at a hotel or another establishment.

In some embodiments, personal concierge application 120 can provide a voice recognition interface 201. Voice recognition interface 201 can be configured to receive and output voice input. For example, voice recognition interface 201 can prompt a user to provide vocal input and then can respond to such vocal input using voice recognition techniques. In some embodiments, personal concierge application 120 can also provide a speech interface 202. Speech interface 202 can allow personal concierge application 120 to provide audible output to the user.

In the remainder of the specification, any reference to mobile computing device 101 receiving input can include receiving vocal input via voice recognition interface 201. Similarly, any reference to mobile computing device 101 providing output can include providing audible output via speech interface 202. However, personal concierge application 120 can be configured to receive input and provide output using other types of interfaces in some embodiments.

The prompts that are provided by voice recognition interface 201 of personal concierge application 120 can be based on the location of mobile computing device 101 within or around a hotel. In other words, personal concierge application 120 is location aware to enable the provision of continuous and personalized concierge services to the user of mobile computing device 101 while the user is a guest at the hotel.

To enable the provision of personalized concierge services from mobile computing device 101, various computing systems or other devices within or near a hotel can be configured to interface with personal concierge application 120. For example, various devices within a guest's room, such as a television, radio, or thermostat can be configured to allow the devices to be controlled by personal concierge application 120.

In some embodiments, such devices can be connected to a network such as a local area network within the hotel. In such cases, the devices can include an interface for receiving commands over the network for controlling the devices (e.g. the devices can be represented by computer system 102 in FIG. 1). Alternatively, each device can include a direct interface for receiving commands directly from a mobile computing device 101 (e.g. the devices can be represented by computer system 103 in FIG. 1).

In some embodiments, a guest can establish an account with personal concierge application 120. Then, when the guest checks in to a hotel, the guest's account can be associated with one or more rooms in the hotel. This association causes any devices located within the associated rooms to recognize and allow communications from personal concierge application 120 on the guest's mobile computing device 101.

For example, each account established with personal concierge application 120 can have an associated unique identifier. When a guest checks in, the hotel can associate the unique identifier of the guest's account with the guest's assigned room. The identifier can be transmitted to or otherwise made known to the devices in the guest's assigned room. The guest can then send commands that include the unique identifier to the devices in the room. The devices can compare the identifier of a command to the identifier that has been associated with the devices in the room to determine whether the command is authorized. If the command is authorized, the device can perform the command.

As can be seen, in this way, the guest is enabled to communicate from his mobile phone or other mobile device with devices in his room. For example, a guest can use personal concierge application 120 to turn on music on a radio or other music device, change the channel on the television, or adjust the thermostat within his hotel room.

As stated above, personal concierge application 120 can provide voice recognition interface 201 for creating commands. For example, personal concierge application 120 can be configured to understand a guest's vocal command to “turn on the television.” To add security to personal concierge application 120, in some embodiments voice recognition interface 201 can authenticate a guest based on the guest's voice. In other words, personal concierge application 120 can only respond to vocal input if the vocal input is identified as being from an authorized user of the account.

In some embodiments, a device can only be controlled from personal concierge application 120 when mobile computing device 101 is within a specified proximity of the device. For example, personal concierge application 120 can be configured to only transmit commands when it determines that mobile computing device 101 is within an appropriate location. In some cases, various sensors can be used to detect when mobile computing device 101 is within the hotel room, on the same floor, within the hotel, within a specified distance from the hotel, etc. When GPS data is available, GPS coordinates can be used to determine the location of mobile computing device 101. Alternatively, location detecting devices can be provided within the hotel. For example, a sensor can detect when a guest has entered the room carrying mobile computing device 101.

Devices that are controllable from personal concierge application 120 can also be positioned outside of a guest's room. For example, a device can be located within the lobby, in a restaurant within the hotel, in the gym, or in any other public area of the hotel. Such devices can be configured to allow control from many different personal concierge applications 120 (e.g. based on the unique identifier associated with a guest's account).

For example, personal concierge application 120 can be interfaced with a reservation system for a hotel restaurant, or with a room service system of the hotel. Accordingly, a guest can use personal concierge application 120 to make reservations at the hotel restaurant, or order room service. In such cases, the unique identifier associated with the guest's account can be used to identify each request or communication from personal concierge application 120.

Personal concierge application 120 can also be configured to provide prompts based on the location of mobile computing device 101. For example, as a guest travels around a hotel, personal concierge application 120 can detect the location of mobile computing device 101 using GPS data or data received from other devices. Based on the guest's location, personal concierge application 120 can output an audible question or inform the guest of some information relevant to the location.

For example, if the guest is located at a famous location within the hotel, personal concierge application 120 can inform the guest of the location and ask the guest if he would like a picture taken in the location. Based on the guest's vocal response, personal concierge application 120 can then instruct the guest to take a picture with mobile computing device 101 or to position himself in front of a camera in the hotel that is controllable by personal concierge application 120. After the picture is taken, personal concierge application 120 can ask the guest whether he would like the picture transferred to any location or account (e.g. Facebook, Twitter, email, a computer system in the guest's room, etc.).

Personal concierge application 120 can also use the location of mobile computing device 101 to provide a tour of a hotel. For example, personal concierge application 120 can output information relevant to the location of the guest within the hotel as it guides the guest along a tour of the hotel.

Personal concierge application 120 can also be configured to provide directions, maps, or other information regarding other locations near the hotel. For example, a guest can vocally ask personal concierge application 120 what restaurants are near the hotel. Personal concierge application 120 can then display, graphically or audibly, recommended local restaurants. The guest can then vocally ask personal concierge application 120 to make a reservation at a particular restaurant. Personal concierge application 120 can use stored information or prompt the guest for information that is required to place a reservation.

In some embodiments, personal concierge application 120 learns preferences or habits of the guest. For example, personal concierge application 120 can detect, based on previous guest interaction with personal concierge application 120, that the guest usually requests room service at 10:00 AM. Based on this previous interaction, as 10:00 AM approaches, personal concierge application 120 can automatically ask the guest whether he would like to order room service, and can even ask whether the guest would like to place his typical order.

If the guest happens to be outside of his room at 10:00 AM, personal concierge application 120 can automatically locate a restaurant or other establishment near the guest that sells items that the guest usually orders at 10:00 AM. Personal concierge application 120 can then prompt the guest to visit the restaurant or establishment to obtain the items.

Similarly, personal concierge application 120 can learn that the guest usually turns the television on to a particular channel upon entering the room. Accordingly, personal concierge application 120 can automatically send a command (or ask the guest whether a command should be sent) to the television to tune the television to the particular channel whenever the guest enters the room.

Personal concierge application 120 can also retain learned information about a guest for use when the guest visits another hotel. For example, if the guest regularly uses personal concierge application 120 to locate sports bars near a hotel in the evening, personal concierge application 120 can automatically identify local sports bars near any hotel the guest checks into. The identified sports bars can automatically be presented to the guest (e.g. in the evening based on the location of the guest).

Examples of How the Personal Concierge Application can be Used

To better illustrate how personal concierge application 120 provides enhanced user control of devices and personal concierge services, the following description provides various examples of potential uses of personal concierge application 120 within a hotel. Similar uses could also be made in other establishments.

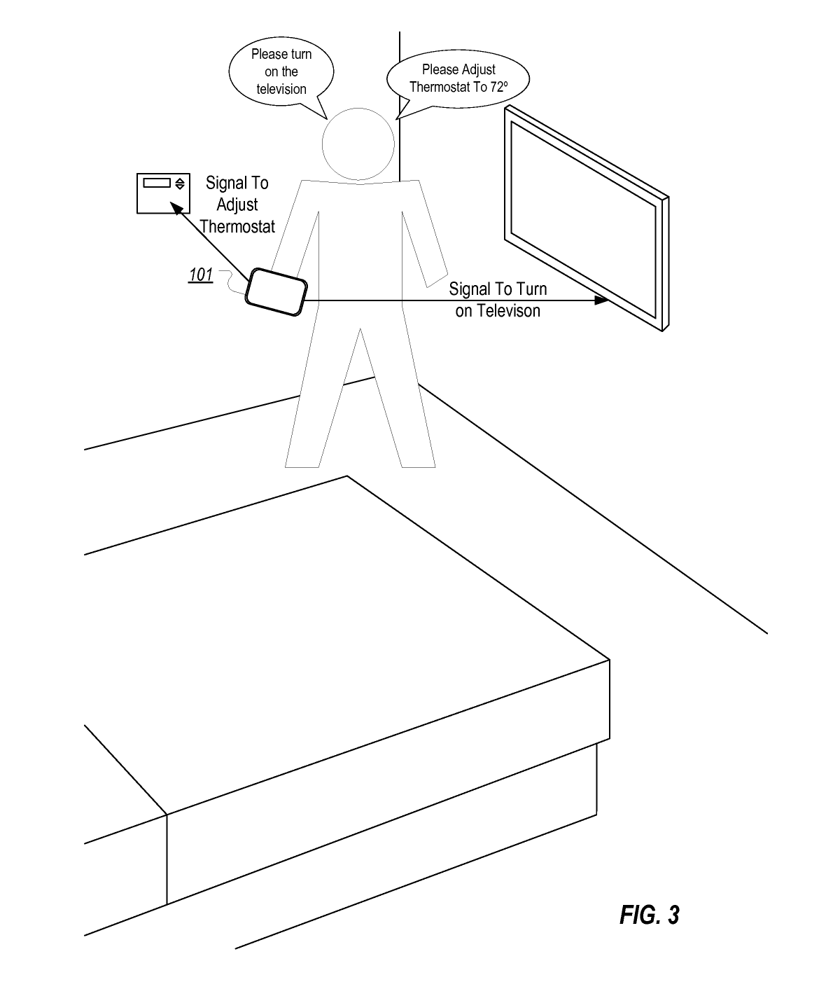

FIG. 3 illustrates an example of how personal concierge application 120 can allow a guest of a hotel to control one or more devices in the guest's room. FIG. 3 represents embodiments where the devices being controlled (the television and thermostat) can be controlled directly by personal concierge application 120. As shown, the user has spoken requests to turn on the television and to set the thermostat to 72°. Personal concierge application 120 can receive and process these requests via voice recognition interface 201. In response, personal concierge application 120 can cause signals to be sent by mobile computing device 101 to the television and thermostat.

As stated above, in some embodiments, an identifier or other type of access code can be assigned to personal concierge application 120 (or more specifically, to the instance of the application executing on the user's mobile device) that can be recognized by the thermostat or television to validate that personal concierge application 120 is authorized to control the devices. In some cases, each device in a room can be configured to understand a unique identifier or access code. In such cases, personal concierge application 120 can use the unique identifier or access code for the particular room in which the user is staying when sending requests to control devices in the room. The unique identifier used by devices in a room can be a static identifier (in which case, each user's personal concierge application can be configured with the unique identifier of the room to which the user is checked in), or a dynamic identifier such as an identifier based on the user's phone number or other identifier of the particular user (in which case, the devices in a room can be updated with the appropriate identifier when each user is checked in to the room).

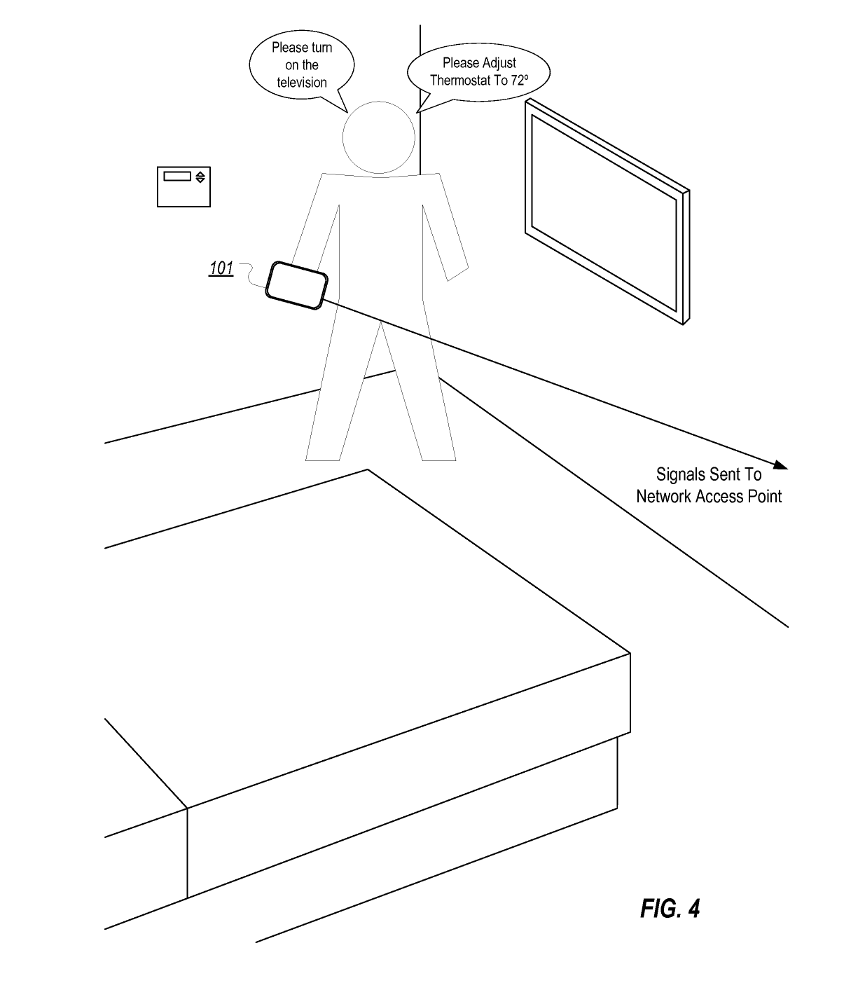

FIG. 4 illustrates an alternative embodiment where personal concierge application 120 does not directly control the devices in the room. In such embodiments, personal concierge application 120 can cause signals to be sent to a network access point (e.g. a router) for a network (e.g. network 110) to which the devices in the room are connected. One or more computer systems (e.g. computer system 102) can receive the signals from mobile computing device 101 and cause appropriate command signals to be sent to the appropriate device to satisfy the request. In FIG. 4, this can be accomplished by a server or other computer system sending commands over a network to turn on the television and to adjust the thermostat.

In such embodiments, personal concierge application 120, another computer system connected to the network, devices located within the room, or some combination of these can be configured to understand a unique identifier or access code to verify that a request is authorized. For example, a server connected to the network can be configured to verify that a request from a personal concierge application contains the appropriate identifier for authorizing control of a device.

Also, in some embodiments, the unique identifier can be used to determine the location (e.g. room) where the request should be sent. For example, because requests are sent over a network rather than directly to the device to be controlled, it may be necessary to identify which device should receive the request. In such cases, a server or other device that receives the request from personal concierge application 120 can use the identifier in the request to determine what device should receive the request. For example, in FIG. 4, a unique identifier in the signal sent to the network access point can be processed to determine that the request to turn on the television should be sent to the television in the room associated with the unique identifier.

Although FIGS. 3 and 4 illustrate direct control and network control being performed separately, in some embodiments of the invention, both types of control can be implemented by personal concierge application 120. For example, some devices in a room may be capable of direct controls while others may not. In such cases, personal concierge application 120 can be configured to generate the appropriate type of signal for the intended device.

In other cases, personal concierge application 120 may not be aware of how a particular device is controlled. In such cases, a common control signal can be used for controlling any device. The common control signal can be understood by devices configured for direct control and can also be received by a network access point so that devices that do not understand the common control signal can still be controlled by employing the network.

Similar techniques can be used by personal concierge application 120 to send control signals to devices that are not located within the user's room. For example, a device in a public area can be configured to be controlled by a number of personal concierge applications 120 (e.g. by the personal concierge application 120 of each user staying in the hotel).

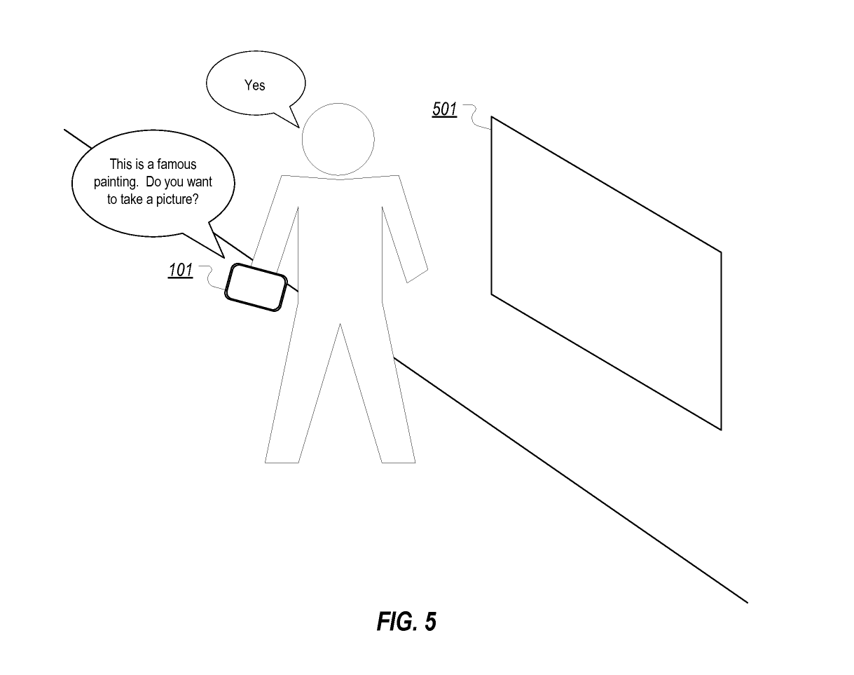

FIG. 5 illustrates an example where personal concierge application 120 determines that the user is near a famous painting 501 in the hotel and asks the user if he would like to take a picture. In response to the user indicating that he would like a picture, personal concierge application 120 can instruct the user to take a picture with mobile computing device 101 or can send a signal to control a separate camera positioned near the famous painting 501.

In some embodiments, personal concierge application 120 can be configured to learn preferences of the user. For example, if the user routinely requests that the television be turned on when he enters the room, personal concierge application 120 can determine that the user has entered his room and ask the user whether he wants to turn on the television, or can automatically turn on the television without asking the user.

Example Methods Performed by the Personal Concierge Application

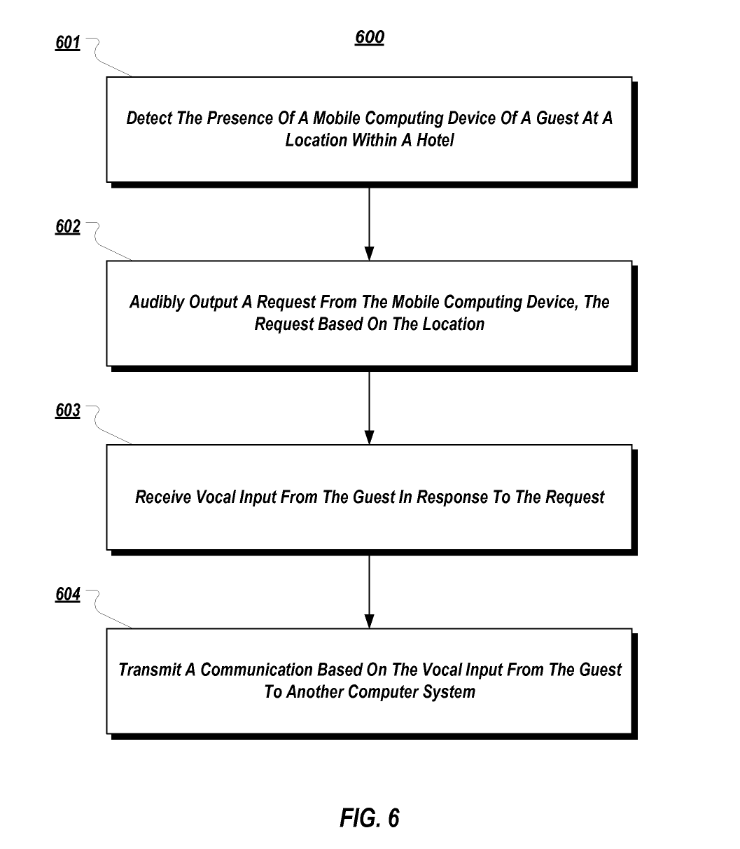

FIG. 6 illustrates a flowchart of a method 600 for providing a personal concierge to a guest of a hotel. Method 600 will be described with reference to FIGS. 1 and 2.

Method 600 includes an act 601 of detecting the presence of a mobile computing device of a guest at a location within a hotel. For example, mobile computing device 101 can detect its location within a hotel. This detection can be performed using data received from computer systems 102 or 103. Examples of the types of locations that can be identified include a guest's room in the hotel, a famous or popular location in the hotel, a location where a service that is potentially of interest to the guest is offered, a location of an attraction that is potentially of interest to the guest, etc.

Method 600 includes an act 602 of audibly outputting a request from the mobile computing device, the request based on the location. For example, mobile computing device 101 can output a request based on the location of mobile computing device 101 within the hotel. In a particular example, personal concierge application 120 can cause mobile computing device 101 to audibly ask the guest whether he would like to take a picture of an item the guest is near, order food from a restaurant the guest has entered, change the channel of a television in a gym, etc.

Method 600 includes an act 603 of receiving vocal input from the guest in response to the request. For example, mobile computing device 101 can receive vocal input from a guest. Examples of the vocal input can include an answer to the request, a question in response to the request, etc.

Method 600 includes an act 604 of transmitting a communication based on the vocal input from the guest to another computer system. For example, mobile computing device 101 can transmit a communication based on the vocal input to computer system 102 or computer system 103. Examples of the communications that can be transmitted include control signals for controlling a device in the hotel, requests for room service, requests for information, etc.

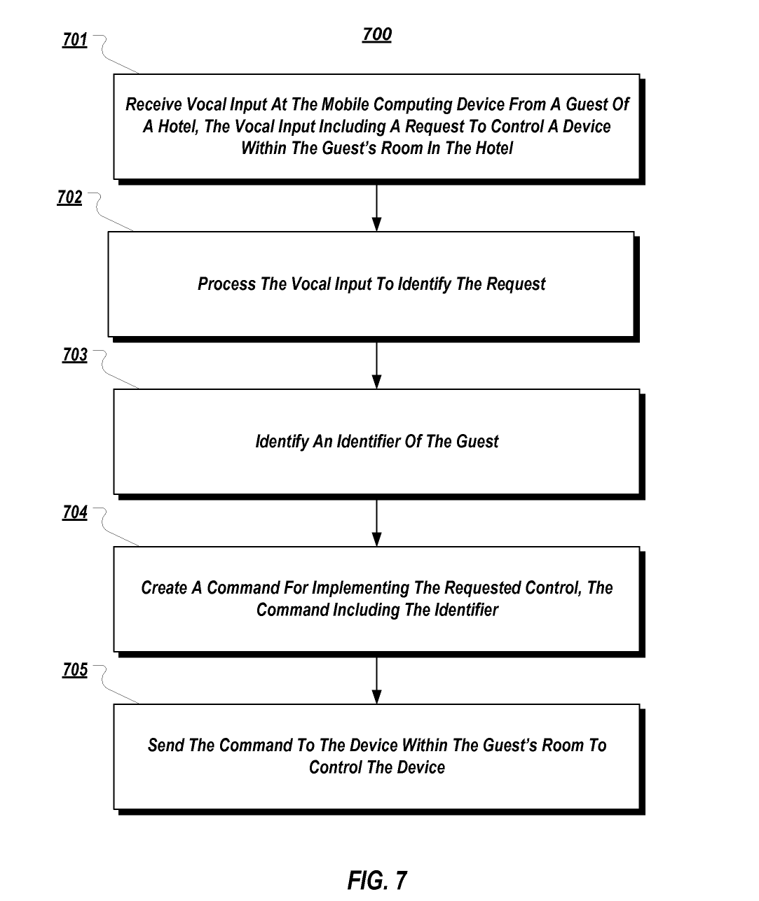

FIG. 7 illustrates a flowchart of a method 700 for providing a personal concierge on a mobile computing device. Method 700 will be described with reference to FIGS. 1 and 2.

Method 700 includes an act 701 of receiving vocal input at a mobile computing device from a guest of a hotel, the vocal input including a request to control a device within the guest's room in the hotel. For example, mobile computing device 101 can receive a vocal command from a guest that requests that a television, thermostat, or other device in the guest's room be controlled.

Method 700 includes an act 702 of processing the vocal input to identify the request. For example, personal concierge application 120 can process the vocal input to identify what is being requested.

Method 700 includes an act 703 of identifying an identifier of the guest. For example, personal concierge application 120 can store an identifier for representing the guest in commands that are sent to devices in the guest's room.

Method 700 includes an act 704 of creating a command for implementing the requested control, the command including the identifier. For example, personal concierge application 120 can generate a command for controlling a device that includes the identifier representing the guest.

Method 700 includes an act 705 of sending the command to the device within the guest's room to control the device. For example, personal concierge application 120 can cause mobile computing device 101 to send the command to the device either by sending the command directly to the device or by routing the command over a network to the device.

As can be seen, personal concierge application 120 provides personal and customized concierge services to guests of a hotel. Using personal concierge application 120, a guest is able to have greater control over his stay at the hotel, and is able to receive customized recommendations or guidance that increase in accuracy as the guest uses the application.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a mobile application on a mobile computing device, for providing a personal concierge to a guest of a hotel, the method comprising:
detecting the presence of a mobile computing device of a guest at a location within a hotel;
audibly outputting a request from the mobile computing device, the request based on the location;
receiving vocal input from the guest in response to the request; and
transmitting a communication based on the vocal input from the guest to another computer system.

2. The method of claim 1, wherein the location comprises the guest's room within the hotel.

3. The method of claim 2, wherein the request comprises a request to control a computer system within the guest's room.

4. The method of claim 3, wherein the computer system within the guest's room comprises a television, radio, or thermostat.

5. The method of claim 2, wherein the request comprises a request to make a reservation for the guest.

6. The method of claim 5, wherein the request is based also on the time of day.

7. The method of claim 5, wherein the request includes suggestions based on the guest's previous interactions with the mobile application while the guest has stayed at the hotel.

8. The method of claim 5, wherein the request includes suggestions based on the guest's previous interactions with the mobile application while the guest has stayed at another hotel.

9. The method of claim 1, wherein the location comprises a famous location with the hotel.

10. The method of claim 9, wherein the request comprises a request to take a picture at the famous location.

11. The method of claim 10, further comprising:
taking a picture with the mobile computing device; and
audibly outputting a prompt to the guest that request whether the guest would like to transfer the picture to another location.

12. The method of claim 1, wherein the communication includes a unique identifier of the guest.

13. The method of claim 1, wherein the request comprises instructions for taking a tour of the hotel.

14. The method of claim 1, wherein the request comprises a request to order room service, and the vocal input comprises the guest's order.

15. One or more computer storage media storing computer executable instructions which when executed by a processor perform a method for providing a personal concierge on a mobile computing device, the method comprising:
receiving vocal input at the mobile computing device from a guest of a hotel, the vocal input including a request to control a device within the guest's room in the hotel;
processing the vocal input to identify the request;
identifying an identifier of the guest;
creating a command for implementing the requested control, the command including the identifier; and
sending the command to the device within the guest's room to control the device.

16. The one or more computer storage media of claim 15, wherein the device comprises a television, a radio, or a thermostat.

17. One or more computer storage media storing a mobile phone application for providing a personal concierge to a guest of a hotel, the mobile phone application comprising computer executable instructions which when executed on a mobile phone perform the following:
detect the location of the mobile phone within a hotel;
based on the location within the hotel, output an audible command to the guest;
in response to the audible command, receive a vocal response from the guest; and
generate a command based on the vocal response to control a device located within the hotel.

18. The one or more computer storage media of claim 17, further comprising;
detect the time of day while the mobile phone is at the location;
wherein the audible command is output to the guest based on the location and the time.

19. The one or more computer storage media of claim 17, further comprising:
storing a history of vocal input from the guest, the history including an identification of a location of the mobile phone and a time when the vocal input was received.

20. The one or more computer storage media of claim 19, further comprising:
audibly outputting a second request from the mobile phone, the second request being based on the history of vocal input and the current location of the mobile phone.
